(19) United States
(12) Patent Application Publication
(10) Pub. No.: US 2024/0203015 A1
(43) Pub. Date: Jun. 20, 2024

(54) MOUTH SHAPE ANIMATION GENERATION METHOD AND APPARATUS, DEVICE, AND MEDIUM

(71) Applicant: Tencent Technology (Shenzhen) Company Limited, Shenzhen (CN)

(72) Inventor: Kai Liu, Guangdong (CN)

(21) Appl. No.: 18/431,272

(22) Filed: Feb. 2, 2024

Related U.S. Application Data
(63) Continuation of application No. PCT/CN23/96852, filed on May 29, 2023.

(30) Foreign Application Priority Data
Aug. 4, 2022 (CN) 202210934101.0

(51) Int. Cl. G06T 13/40; G10L 15/26

(52) U.S. Cl. CPC G06T 13/40; G10L 15/26

(57) ABSTRACT

A mouth shape animation generation method, system, apparatus, and computer-readable medium is described. The process may include: performing feature analysis based on a target audio, to generate viseme feature flow data; the viseme feature flow data including a plurality of sets of ordered viseme feature data; each set of viseme feature data being corresponding to one audio frame in the target audio (202); separately parsing each set of viseme feature data, to obtain viseme information and intensity information corresponding to the viseme feature data; the intensity information being used for characterizing a change intensity of a viseme corresponding to the viseme information (204); and controlling, according to the viseme information and the intensity information corresponding to the sets of viseme feature data, a virtual face to change, so as to generate a mouth shape animation corresponding to the target audio (206).

### RELATED APPLICATION

This application claims priority to Chinese Patent Application No. 202210934101.0, entitled “MOUTH SHAPE ANIMATION GENERATION METHOD AND APPARATUS, DEVICE, AND MEDIUM” filed with the Patent Office of China on Aug. 4, 2022, and is a continuation of PCT Application No. PCT/CN2023/096852, both of which are incorporated by reference herein in their entirety.

### TECHNICAL FIELD

This application relates to an animation generation technology, and in particular, to a mouth shape animation generation method, apparatus, a device, and a medium.

### BACKGROUND

In many animation scenarios, virtual objects often speak or have conversations. During speaking or conversations between the virtual objects, corresponding mouth shape animations are needed for presenting. For example, in an electronic game scenario, mouth shape animations need to be generated to present a scenario in which virtual objects (for example, virtual characters) speak or have conversations, so as to make the game to be more vivid and realistic. In conventional technologies, generally, an artist is first required to manually produce dozens of mouth shapes, and then an animator performs animation production based on the mouth shapes produced by the artist in advance, to obtain corresponding mouth shape animations. However, this way of manually producing mouth shape animations requires a lot of production time, resulting in low efficiency.

### SUMMARY

On that basis, it is desirable to provide a mouth shape animation generation method, apparatus, device, and medium for at least the foregoing technical problem.

A first aspect provides a mouth shape animation generation method, executed by a terminal, including:
performing feature analysis based on a target audio, to generate viseme feature flow data; the viseme feature flow data including a plurality of sets of ordered viseme feature data; each set of viseme feature data being corresponding to one audio frame in the target audio;
separately parsing each set of viseme feature data, to obtain viseme information and intensity information corresponding to the viseme feature data; the intensity information being used for characterizing a change intensity of a viseme corresponding to the viseme information; and
controlling, according to the viseme information and the intensity information corresponding to the sets of viseme feature data, a virtual face to change, so as to generate a mouth shape animation corresponding to the target audio.

A second aspect provides a mouth shape animation generation apparatus, including:
a generation module, configured to perform feature analysis based on a target audio, to generate viseme feature flow data; the viseme feature flow data including a plurality of sets of ordered viseme feature data; each set of viseme feature data being corresponding to one audio frame in the target audio;
a parsing module, configured to separately parse each set of viseme feature data, to obtain viseme information and intensity information corresponding to the viseme feature data; the intensity information being used for characterizing a change intensity of a viseme corresponding to the viseme information; and
a control module, configured to control, according to the viseme information and the intensity information corresponding to the sets of viseme feature data, a virtual face to change, so as to generate a mouth shape animation corresponding to the target audio.

A third aspect provides a computer device, including a memory and one or more processors, the memory storing computer-readable instructions, and the processor, when executing the computer-readable instructions, implementing the steps in the method embodiments of this application.

A fourth aspect provides one or more computer-readable storage media, storing computer-readable instructions, and the computer-readable instructions, when executed by one or more processors, causing the one or more processors to perform the steps in the method embodiments of this application.

A fifth aspect provides a computer program product, including computer-readable instructions, and the computer-readable instructions, when executed by one or more processors, causing the one or more processors to perform the steps in the method embodiments of this application.

Details of one or more aspects described herein are provided in the accompanying drawings and descriptions below. Other features, objectives, and advantages become apparent from the specification, the drawings, and the claims.

### BRIEF DESCRIPTION OF THE DRAWINGS

To describe technical solutions more clearly, the following briefly introduces the accompanying drawings required for describing aspects of the disclosure. The accompanying drawings in the following description show only some aspects, and a person of ordinary skill in the art may still derive other drawings from these accompanying drawings without creative efforts.

FIG. 1 is a diagram of an application environment of a mouth shape animation generation method according to one or more aspects described herein;

FIG. 2 is a schematic flowchart of a mouth shape animation generation method according to one or more aspects described herein;

FIG. 3 is a schematic diagram of viseme feature flow data according to an embodiment;

FIG. 4 is a schematic diagram of visemes in a viseme list according to one or more aspects described herein;

FIG. 5 is a schematic diagram of intensities of visemes according to one or more aspects described herein;

FIG. 6 is a schematic diagram of mapping relationships among phonemes and visemes according to one or more aspects described herein;

FIG. 7 is a schematic diagram of principles for parsing each set of viseme feature data according to one or more aspects described herein;

FIG. 8 is a schematic diagram of co-pronunciation visemes according to one or more aspects described herein;

FIG. 9 is a schematic diagram of an animation production interface according to one or more aspects described herein;

FIG. 10 is a schematic description diagram of action units according to one or more aspects described herein;

FIG. 11 is a schematic diagram of principles for action units to control corresponding regions of a virtual face according to one or more aspects described herein;

FIG. 12 is a schematic diagram of some basic action units according to one or more aspects described herein;

FIG. 13 is a schematic diagram of some additional action units according to one or more aspects described herein;

FIG. 14 is an example schematic diagram of mapping relationships among phonemes, visemes, and action units according to one or more aspects described herein;

FIG. 15 is another example schematic diagram of an animation production interface according to one or more aspects described herein;

FIG. 16 is a schematic diagram of an animation playing curve according to one or more aspects described herein;

FIG. 17 is an overall architecture diagram of generation of a mouth shape animation according to one or more aspects described herein;

FIG. 18 is a schematic flowchart of operations of generation of a mouth shape animation according to one or more aspects described herein;

FIG. 19 is a schematic diagram of generation of an asset file according to a first process of one or more aspects described herein;

FIG. 20 is a schematic diagram of generation of an asset file according to a second process of one or more aspects described herein;

FIG. 21 is a schematic diagram of generation of an asset file according to a third process of one or more aspects described herein;

FIG. 22 is a schematic diagram of an operating interface for adding a target audio and a corresponding virtual object character for a pre-created animation sequence according to one or more aspects described herein;

FIG. 23 is a schematic diagram of an operating interface for automatically generating a mouth shape animation according to one or more aspects described herein;

FIG. 24 is a schematic diagram of a finally generated mouth shape animation according to a first process of one or more aspects described herein;

FIG. 25 is a schematic flowchart of a mouth shape animation generation method according to a second process of one or more aspects described herein;

FIG. 26 is a structural block diagram of a mouth shape animation generation apparatus according to one or more aspects described herein; and

FIG. 27 is a diagram of an internal structure of a computer device according to one or more aspects described herein.

### DETAILED DESCRIPTION

To make the objectives, technical solutions, and advantages clearer, the following further describes aspects of the present disclosure in detail with reference to the accompanying drawings. It is to be understood that the description provided herein are only used for explaining the various aspects, and are not limiting.

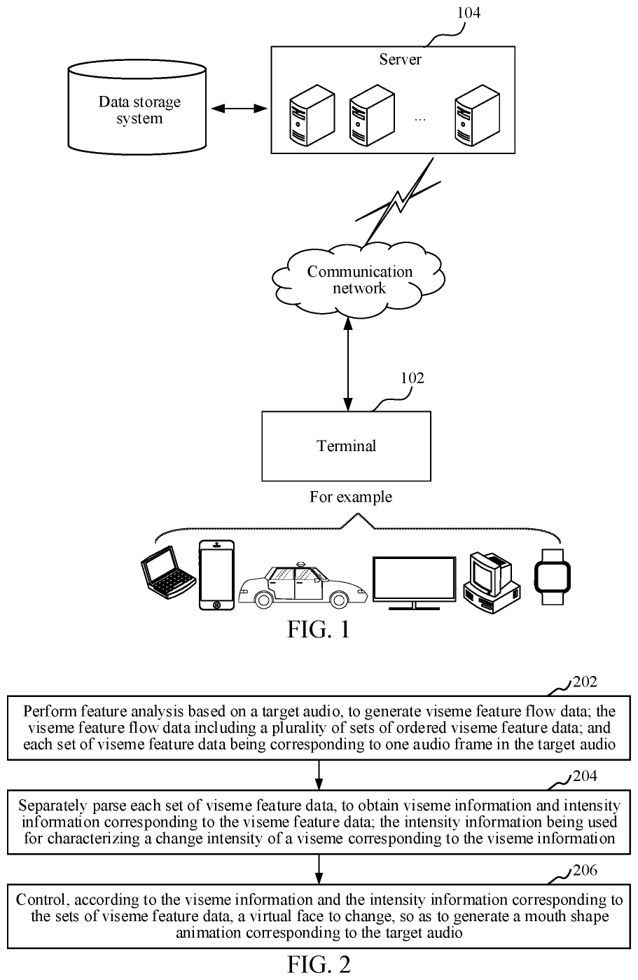

The mouth shape animation generation method may be applied to an application environment shown in FIG. 1. A terminal 102 may communicate with a server 104 via a network. A data storage system may store data that the server 104 needs to process. The data storage system may be integrated on the server 104, or may be placed on a cloud or other servers. The terminal 102 may be, but is not limited to, a desktop computer, a laptop, a smart phone, a tablet computer, an Internet of Things device, and a portable wearable device. An Internet of Things device may be a smart speaker, a smart TV set, a smart air conditioner, an intelligent in-vehicle device, or the like. The portable wearable device may be a smart watch, a smart bracelet, a head-worn device, or the like. The server 104 may be an independent physical server, or a server cluster or distributed system composed of a plurality of physical servers, or may be a cloud server for providing basic cloud computing services, such as a cloud service, a cloud database, cloud computing, a cloud function, cloud storage, a network service, cloud communication, a middleware service, a domain name service, a security service, a CDN, big data, and an artificial intelligence platform. The terminal 102 and the server 104 may be directly or indirectly connected in a wired or wireless communication manner, but is not limited to these methods of communication.

The terminal 102 may perform feature analysis based on a target audio, to generate viseme feature flow data. The viseme feature flow data includes a plurality of sets of ordered viseme feature data. Each set of viseme feature data corresponds to one audio frame in the target audio. The terminal 102 may separately parse each set of viseme feature data, to obtain viseme information and intensity information corresponding to the viseme feature data. The intensity information is used for characterizing a change intensity of a viseme corresponding to the viseme information. The terminal 102 may control, according to the viseme information and the intensity information corresponding to the sets of viseme feature data, a virtual face to change, so as to generate a mouth shape animation corresponding to the target audio.

It may be understood that the server 104 may transmit the target audio to the terminal 102, and the terminal 102 may perform feature analysis based on the target audio, to generate viseme feature flow data. It may further be understood that, the terminal 102 may transmit the generated mouth shape animation corresponding to the target audio to the server 102 for storage. The application scenario in FIG. 1 is only for schematic description, and the aspects described herein are not limited to this scenario.

Additionally, artificial intelligence may be used in the mouth shape animation generation method according to some aspects of the disclosure. For example, the viseme feature flow data may be obtained through parsing by using the artificial intelligence technology.

As shown in FIG. 2, a mouth shape animation generation method is provided, and in this example process, a description is provided in which the method is applied to the terminal 102 in FIG. 1. This method may include the following steps.

Step 202: Perform feature analysis based on a target audio, to generate viseme feature flow data. The viseme feature flow data may include a plurality of sets of ordered viseme feature data. Each set of viseme feature data corresponds to one audio frame in the target audio.

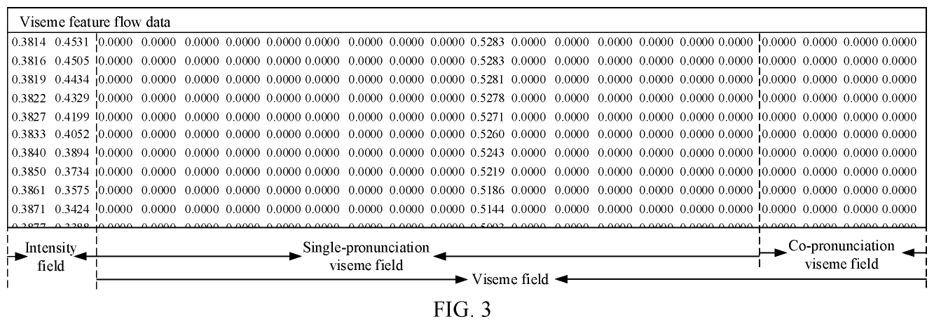

The viseme feature flow data may be flow type data for characterizing viseme features. The viseme feature flow data may be composed of a plurality of sets of ordered viseme feature data. The viseme feature data may be a single set of data for characterizing a feature of a corresponding viseme. It may be understood that one set of viseme feature data corresponds to one frame of audio frame in the target audio, and one set of viseme feature data may be used for describing a viseme feature. For example, referring to FIG. 3, one set of viseme feature data in the viseme feature flow data is “0.3814, 0.4531, 0.0000, 0.0000, 0.0000, 0.0000, 0.0000, 0.0000, 0.0000, 0.0000, 0.0000, 0.5283, 0.0000, 0.0000, 0.0000, 0.0000, 0.0000, 0.0000, 0.0000, 0.0000, 0.0000, 0.0000”, where the values “0.0000, 0.0000, 0.0000, 0.0000, 0.0000, 0.0000, 0.0000, 0.0000, 0.0000, 0.5283, 0.0000, 0.0000, 0.0000, 0.0000, 0.0000, 0.0000, 0.0000, 0.0000, 0.0000, 0.0000” corresponding to twenty viseme fields are used for describing twenty preset visemes, respectively. It may be seen from this set of viseme feature data that only the value corresponding to the tenth viseme field is a non-zero value, namely, “0.5283”. Therefore, this set of viseme feature data can be used for outputting the viseme corresponding to the tenth viseme field to a user. The values corresponding to the two intensity fields “0.3814, 0.4531” may be used for describing change intensities of the driven viseme (that is, the viseme corresponding to the tenth viseme field). The viseme is a visualized unit of a mouth shape. It may be understood that the visualized mouth shape is a viseme. It may be understood that, in a case that a virtual character speaks, the mouth of the virtual character generates different mouth shapes (that is, visemes) according to different speaking content. For example, in a case that the virtual character says “a”, the mouth of the virtual character may present a viseme that matches the pronunciation of “a”.

In one example, a terminal may obtain a target audio and perform framing processing on the target audio, to obtain a plurality of audio frames. For each set of audio frames, the terminal may perform feature analysis on the audio frames, to obtain viseme feature data corresponding to the audio frames. Further, the terminal may generate, according to the viseme feature data separately corresponding to the audio frames, viseme feature flow data corresponding to the target audio.

According to one aspect, the terminal may perform the feature analysis based on the target audio, to obtain phoneme flow data. Further, the terminal may perform analysis processing on the phoneme flow data, to generate the viseme feature flow data corresponding to the target audio. The phoneme flow data is flow type data composed of phonemes. The phoneme is a minimum phonetic unit obtained by performing division according to a natural attribute of voice. For example, the Chinese phrase “ [symbol] ” is composed of eight phonemes, namely, “p, u, t, o, ng, h, u, a”.

FIG. 3 illustrates part of the viseme feature flow data. The viseme feature flow data may include a plurality of sets of ordered viseme feature data (it may be understood that each row corresponds to a set of viseme feature data in FIG. 3), and each set of viseme feature data may correspond to one audio frame in the target audio.

Step 204: Separately parse each set of viseme feature data, to obtain viseme information and intensity information corresponding to the viseme feature data. The intensity information may be used for characterizing a change intensity of a viseme corresponding to the viseme information.

The viseme information may be information for describing a viseme. For case of understanding, for example, referring to FIG. 3, one set of viseme feature data in the viseme feature flow data is “0.3814, 0.4531, 0.0000, 0.0000, 0.0000, 0.0000, 0.0000, 0.0000, 0.0000, 0.0000, 0.0000, 0.5283, 0.0000, 0.0000, 0.0000, 0.0000, 0.0000, 0.0000, 0.0000, 0.0000, 0.0000, 0.0000”, and after the set of viseme feature data is parsed, the viseme information corresponding to the set of viseme feature data can be obtained. It may be seen from this set of viseme feature data that only the value corresponding to the tenth viseme field is a non-zero value, namely, “0.5283”. Therefore, this set of viseme feature data can be used for outputting the viseme corresponding to the tenth viseme field to a user. Further, the viseme information corresponding to the set of viseme feature data can be used for describing adjoint intensity information of the viseme corresponding to the tenth viseme field (that is, the adjoint intensity of the viseme corresponding to the tenth viseme field is 0.5283). It may be understood that the adjoint intensity information may be independent of the parsed intensity information and is not affected by the parsed intensity information. It may be understood that, for each set of viseme feature data, the viseme information corresponding to the set of viseme feature data may be used for indicating the viseme corresponding to the set of viseme feature data.

Specifically, the viseme feature data may include at least one feature field. The terminal may separately parse each feature field in each set of viseme feature data, to obtain viseme information and intensity information corresponding to the viseme feature data. The feature field may be a field used for describing a viseme feature.

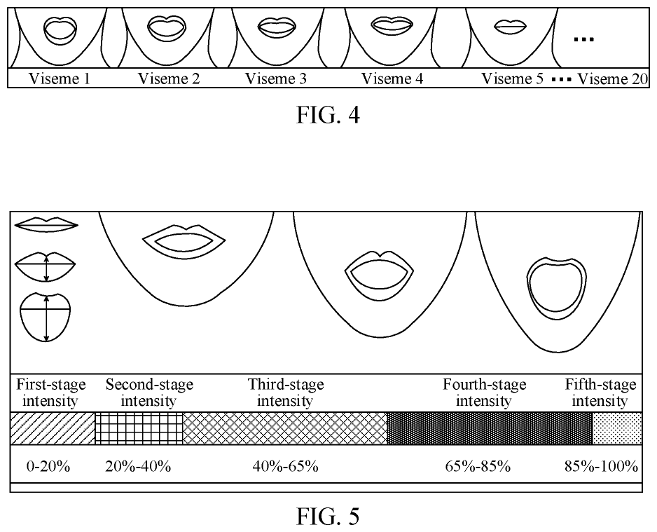

Referring to FIG. 4, a preset viseme list includes 20 viseme, namely, a viseme 1 to a viseme 20.

According to some aspects, the intensity information may be used for characterizing a change intensity of a viseme corresponding to the viseme information. As shown in FIG. 5, the intensity information may be divided into five stages of intensity information, namely, an intensity change range corresponding to intensity information of a first stage is 0-20%, an intensity change range corresponding to intensity information of a second stage is 20%-40%, an intensity change range corresponding to intensity information of a third stage is 40%-65%, an intensity change range corresponding to intensity information of a fourth stage is 65%-85%, and an intensity change range corresponding to intensity information of a fifth stage is 85%-100%. For example, by parsing a particular set of viseme feature data, viseme information and intensity information corresponding to the set of viseme feature data can be obtained. In a case that a viseme outputted under control by the viseme information corresponding to the set of viseme feature data is the viseme 1 in FIG. 4, the intensity information corresponding to the set of viseme feature data may be used for characterizing a change intensity of the viseme 1.

Step 206: Control, according to the viseme information and the intensity information corresponding to the sets of viseme feature data, a virtual face to change, so as to generate a mouth shape animation corresponding to the target audio.

The virtual face may be a face of a virtual object. The mouth shape animation may be an animation sequence composed of a plurality of frames of mouth shape key frames.

In one example, for each set of viseme feature data, the terminal may control, according to the viseme information and the intensity information corresponding to the set of viseme feature data, the virtual face to produce a change, to obtain a mouth shape key frame corresponding to the set of viseme feature data. Further, the terminal may generate a mouth shape animation corresponding to the target audio according to the mouth shape key frames respectively corresponding to the sets of viseme feature data.

In the mouth shape animation generation method, feature analysis may be performed based on the target audio, to generate viseme feature flow data. The viseme feature flow data may include a plurality of sets of ordered viseme feature data, and each set of viseme feature data may correspond to one frame of audio frame in the target audio. By separately parsing each set of viseme feature data, the viseme information and the intensity information corresponding to the viseme feature data can be obtained, and the intensity information may be used for characterizing a change intensity of the viseme corresponding to the viseme information. The viseme information may be used for indicating a corresponding viseme and the intensity information may be used for indicating a degree of relaxation of the corresponding viseme. Therefore, according to the viseme information and the intensity information corresponding to the sets of viseme feature data, the virtual face can be controlled to generate a corresponding change, so as to automatically generate the mouth shape animation corresponding to the target audio. Compared with the conventional method of manually producing a mouth shape animation, by parsing the target audio into viseme feature flow data capable of driving the virtual face to produce a change as described herein, the virtual face may be automatically driven by the viseme feature flow data to produce a change, so as to automatically generate the mouth shape animation corresponding to the target audio, thereby shortening the generation time of the mouth shape animation and improving the generation efficiency of the mouth shape animation generation process.

According to one or more aspects, the performing feature analysis based on a target audio, to generate viseme feature flow data includes: performing the feature analysis based on the target audio, to obtain phoneme flow data; the phoneme flow data including a plurality of sets of ordered phoneme data; each set of phoneme data being corresponding to one audio frame in the target audio; for each set of phoneme data, performing analysis processing on the phoneme data according to a preset mapping relationship between a phoneme and a viseme, to obtain viseme feature data corresponding to the phoneme data; and generating the viseme feature flow data according to the viseme feature data respectively corresponding to the sets of phoneme data.

Specifically, the terminal may obtain a target audio, and perform feature analysis on each audio frame in the target audio, to obtain the phoneme flow data corresponding to the target audio. For each set of phoneme data in the phoneme flow data, the terminal may perform analysis processing on the phoneme data according to a preset mapping relationship between a phoneme and a viseme, to obtain viseme feature data corresponding to the phoneme data. Further, the terminal may generate viseme feature flow data according to the viseme feature data respectively corresponding to the sets of phoneme data.

In some examples, the terminal may directly perform feature analysis on the target audio, to obtain the phoneme flow data corresponding to the target audio.

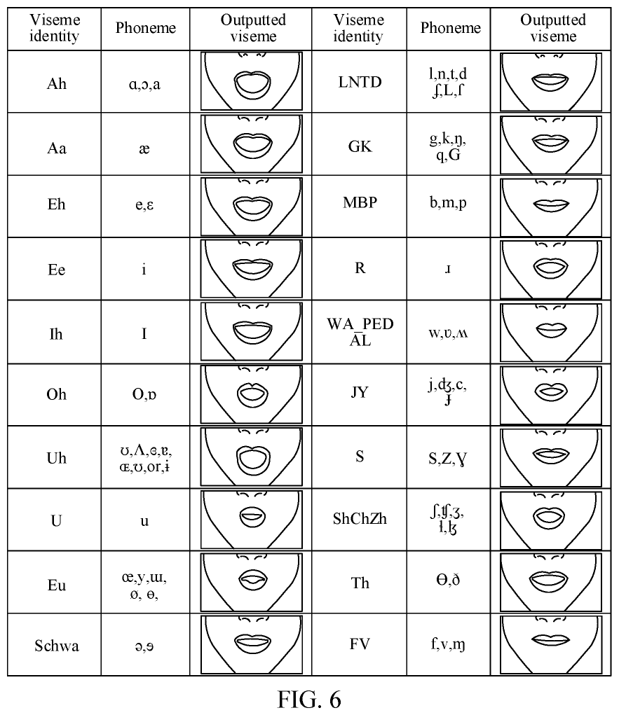

An example preset mapping relationship between a phoneme and a viseme is illustrated in FIG. 6. As can be seen from FIG. 6, one viseme can be mapped with one or more phonemes.

In the foregoing, by parsing the target audio to obtain the phoneme flow data and further performing the analysis processing on the phoneme data according to the preset mapping relationship between the phoneme and the viseme, the viseme feature data corresponding to the phoneme data can be obtained, thereby improving the accuracy of the viseme feature flow data.

In one or more examples, the performing the feature analysis based on the target audio, to obtain phoneme flow data includes: determining a text matching the target audio; and performing alignment processing on the target audio and the text, and generating the phoneme flow data by parsing according to an alignment processing result.

In one arrangement, the terminal may obtain the text matching the target audio, and obtain reference phoneme flow data corresponding to the text. The terminal may perform speech recognition on the target audio, to obtain initial phoneme flow data. Further, the terminal may align the initial phoneme flow data and the reference phoneme flow data, to obtain the phoneme flow data corresponding to the target audio. Aligning the initial phoneme flow data and the reference phoneme flow data may be understood as performing checking for defects and leaks for phonemes in the initial phoneme flow data by using the reference phoneme flow data. For example, the target audio is the Chinese phrase “ [symbol] ”, which is composed of eight phonemes, namely, “p, u, t, o, ng, h, u, a”. The terminal performs speech recognition on the target audio, and the obtained initial phoneme flow data may be “p, u, t, ng, h, u, a”, with the fourth phoneme “o” missing. In this case, the terminal may supplement the missing “o” to the initial phoneme flow data by using the reference phoneme flow data “p, u, t, o, ng, h, u, a” corresponding to the text, to obtain the phoneme flow data “p, u, t, o, ng, h, u, a” corresponding to the target audio. In this way, the accuracy of the obtained phoneme flow data can be improved.

In some arrangements, the terminal may perform speech recognition on the target audio, to obtain the text matching the target audio. Additionally or alternatively, the terminal may also directly obtain the text matching the target audio.

For case of understanding, for example, in case that the speech data recorded by the target audio is “Putonghua” that a user is currently saying, the text records three Chinese characters “ [symbol] ” in a text form, the text is a text matching the target audio.

In the foregoing, by performing alignment processing on the target audio and the text matching the target audio and generating phoneme flow data by parsing according to the alignment processing result, the accuracy of the phoneme flow data can be improved, thereby further improving the accuracy of the viseme feature flow data.

In one or more arrangements, the viseme feature data may include at least one viseme field and at least one intensity field; the separately parsing each set of viseme feature data, to obtain viseme information and intensity information corresponding to the viseme feature data includes: separately mapping, for each set of viseme feature data, viseme fields in the viseme feature data with visemes in a preset viseme list according to a preset mapping relationship between a viseme field and a viseme, to obtain the viseme information corresponding to the viseme feature data; and parsing the intensity field in the viseme feature data, to obtain the intensity information corresponding to the viseme feature data.

The viseme field may be a field for describing the type of the viseme. The intensity field may be a field for describing an intensity of the viseme.

It may be understood that the feature fields in the viseme feature data include at least one viseme field and at least one intensity field.

Referring to FIG. 3, the viseme feature flow data shown in FIG. 3 includes two intensity fields and 20 viseme fields. It may be understood that, in FIG. 3, each floating point value corresponds to one field.

For example, for each set of viseme feature data, the terminal may separately map the viseme fields in the viseme feature data with visemes in a preset viseme list (that is, the visemes in the viseme list shown in FIG. 4) according to a preset mapping relationship between a viseme field and a viseme, to obtain the viseme information corresponding to the viseme feature data. It may be understood that one viseme field may be mapped to one viseme in the viseme list. The terminal may parse the intensity field in the viseme feature data, to obtain the intensity information corresponding to the viseme feature data.

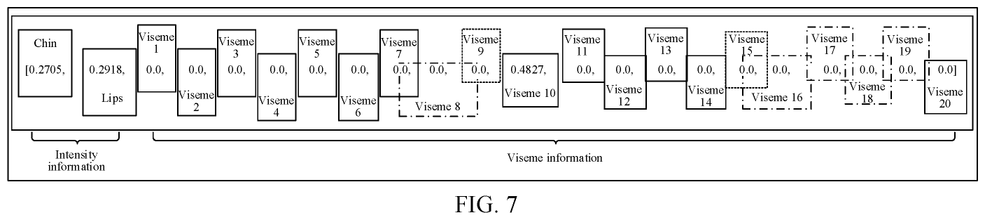

FIG. 7 illustrates a process for parsing a set of viseme feature data. The terminal may separately map the 20 viseme fields in the viseme feature data with 20 visemes (namely, a viseme 1 to a viseme 20) in a preset viseme list, to obtain viseme information corresponding to the viseme feature data, and parse the two intensity fields in the viseme feature data (namely, intensity fields used for characterizing degrees of relaxation of a chin and lips, respectively), to obtain intensity information corresponding to the viseme feature data.

In the foregoing, by separately mapping the viseme fields in the viseme feature data with the viseme fields in the preset viseme list, the viseme information corresponding to the viseme feature data can be obtained, thereby improving the accuracy of the viseme information. By parsing the intensity field in the viseme feature data, the intensity information corresponding to the viseme feature data can be obtained, thereby improving the accuracy of the intensity information.

In one or more examples, the viseme field may include at least one single-pronunciation viseme field and at least one co-pronunciation viseme field; the visemes in the viseme list may include at least one single-pronunciation viseme and at least one co-pronunciation viseme; and the separately mapping, for each set of viseme feature data, viseme fields in the viseme feature data with visemes in a preset viseme list according to a preset mapping relationship between a viseme field and a viseme, to obtain the viseme information corresponding to the viseme feature data may include: separately mapping, for each set of viseme feature data, single-pronunciation viseme fields in the viseme feature data with single-pronunciation visemes in the viseme list according to a preset mapping relationship between a single-pronunciation viseme field and a single-pronunciation viseme; separately mapping co-pronunciation viseme fields in the viseme feature data with co-pronunciation visemes in the viseme list according to a preset mapping relationship between a co-pronunciation viseme field and a co-pronunciation viseme, to obtain the viseme information corresponding to the viseme feature data.

The single-pronunciation viseme field may be a field for describing the type of the single-pronunciation viseme. The co-pronunciation viseme field may be a field for describing the type of the co-pronunciation viseme. The single-pronunciation viseme may be a viseme for single-pronunciation. The co-pronunciation viseme is may be a viseme for co-pronunciation.

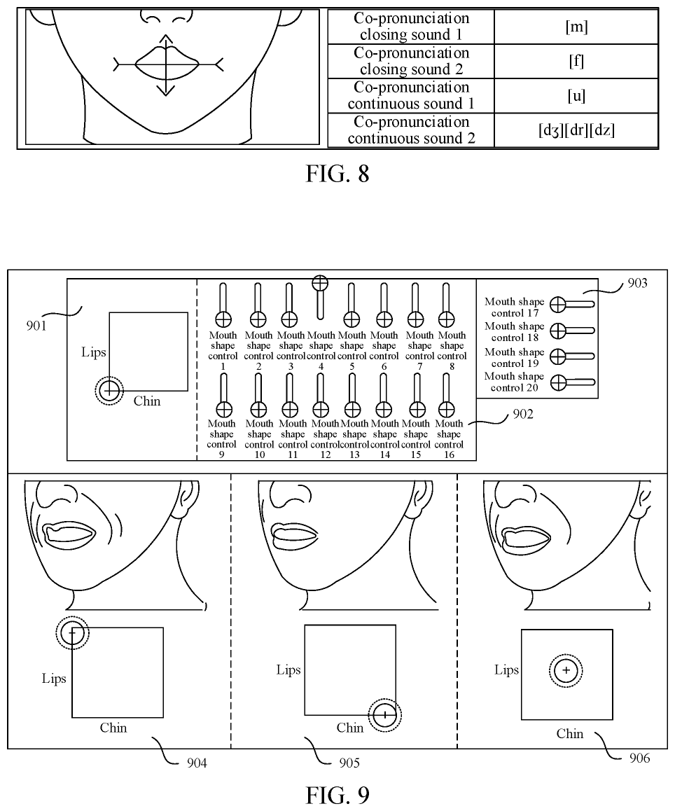

As shown in FIG. 8, the co-pronunciation may include two closing sounds in a vertical direction, namely, a co-pronunciation closing sound 1 and a co-pronunciation closing sound 2. The co-pronunciation also may include two horizontal continuous sounds, namely, a co-pronunciation continuous sound 1 and co-pronunciation continuous sound 2.

For example, in a case that “s” sound is made in “sue”, “s” needs to be immediately followed by “u” sound, for which a pout is generated, and in a case that “s” sound is made in “see”, no “u” sound appears after “s”. In other words, during utterance of “sue”, the continuous sound “u” needs to be activated, and during utterance of “see”, there is no need to activate a continuous sound. It may be understood that there is a co-pronunciation viseme during the utterance of “sue” and there is a single-pronunciation viseme in during the utterance of “see”.

Referring to the example of FIG. 3, the viseme fields may include 16 single-pronunciation viseme fields and four co-pronunciation viseme fields.

For example, for each set of viseme feature data, the terminal may separately map single-pronunciation viseme fields in the viseme feature data with single-pronunciation visemes in a viseme list according to a preset mapping relationship between a single-pronunciation viseme field and a single-pronunciation viseme, and it may be understood that one single-pronunciation viseme field may be mapped to one single-pronunciation viseme in the viseme list. The terminal may separately map co-pronunciation viseme fields in the viseme feature data with co-pronunciation visemes in the viseme list according to a preset mapping relationship between a co-pronunciation viseme field and a co-pronunciation viseme, to obtain the viseme information corresponding to the viseme feature data. It may be understood that one co-pronunciation viseme field may be mapped to a co-pronunciation viseme in the viseme list.

By separately mapping the single-pronunciation viseme fields in the viseme feature data with the single-pronunciation visemes in the viseme list, the mapping accuracy between the single-pronunciation viseme field and the single-pronunciation viseme can be improved. In addition, by separately mapping the co-pronunciation viseme fields in the viseme feature data with the co-pronunciation visemes in the viseme list, the mapping accuracy between the co-pronunciation viseme fields and the co-pronunciation visemes can be improved, so that the accuracy of the obtained viseme information corresponding to the viseme feature data can be improved.

In one or more examples, the controlling, according to the viseme information and the intensity information corresponding to the sets of viseme feature data, a virtual face to change, so as to generate a mouth shape animation corresponding to the target audio may include: assigning, for each set of viseme feature data, values to mouth shape controls in an animation production interface by using the viseme information corresponding to the viseme feature data; assigning values to intensity controls in the animation production interface by using the intensity information corresponding to the viseme feature data; controlling, by using the value-assigned mouth shape controls and the value-assigned intensity controls, a virtual face to change, so as to generate a mouth shape key frame corresponding to the viseme feature data; and generating a mouth shape animation corresponding to the target audio according to the mouth shape key frames respectively corresponding to the sets of viseme feature data.

The animation production interface may be a visualized interface for producing a mouth shape animation. The mouth shape control may be a visualized control for controlling to output a viseme. The intensity control may be a visualized control for controlling a change intensity of a viseme.

In one or more examples, for each set of viseme feature data, the terminal may automatically assign a value to the mouth shape control in the animation production interface of the terminal by using the viseme information corresponding to the viseme feature data, and in addition, the terminal may also automatically assign a value to the intensity control in the animation production interface of the terminal by using the intensity information corresponding to the viseme feature data. Further, the terminal may automatically control, by using the value-assigned mouth shape controls and the value-assigned intensity controls, a virtual face to change, so as to generate a mouth shape key frame corresponding to the viseme feature data. The terminal may generate a mouth shape animation corresponding to the target audio according to the mouth shape key frames respectively corresponding to the sets of viseme feature data.

As shown in FIG. 9, an example animation production interface includes 20 mouth shape controls (namely, a mouth shape control 1 to a mouth shape control 16 shown in 902, and a mouth shape control 17 to a mouth shape control 20 shown in 903 in FIG. 9), and intensity controls (namely, controls shown in 901 in FIG. 9) respectively corresponding to the corresponding mouth shape controls.

By automatically assigning a value to the mouth shape control in the animation production interface by using the viseme information corresponding to the viseme feature data, and by automatically assigning a value to the intensity control in the animation production interface by using the intensity information corresponding to the viseme feature data, the virtual face may be automatically controlled to change by using the value-assigned mouth shape controls and the value-assigned intensity controls, so as to generate a mouth shape animation corresponding to the target audio, so that the process of generating the mouth shape animation can be automated, thereby improving the generation efficiency of the mouth shape animation.

In one or more examples, the viseme information may include at least one single-pronunciation viseme parameter and at least one co-pronunciation viseme parameter; the mouth shape controls may include at least one single-pronunciation mouth shape control and at least one co-pronunciation mouth shape control; and the assigning, for each set of viseme feature data, values to mouth shape controls in an animation production interface by using the viseme information corresponding to the viseme feature data may include: separately assigning, for each set of viseme feature data, values to single-pronunciation mouth shape controls in the animation production interface by using the single-pronunciation viseme parameters corresponding to the viseme feature data; and separately assigning values to co-pronunciation mouth shape controls in the animation production interface by using the co-pronunciation viseme parameters corresponding to the viseme feature data.

The single-pronunciation viseme parameter may be a parameter corresponding to a single-pronunciation viseme. The co-pronunciation viseme parameter may be a parameter corresponding to a co-pronunciation viseme. The single-pronunciation mouth shape control may be a single-pronunciation viseme corresponding to a mouth shape control. The co-pronunciation mouth shape control may be a mouth shape control corresponding to a co-pronunciation viseme.

Referring to FIG. 7, the example viseme information includes 16 single-pronunciation viseme parameters (namely, viseme parameters corresponding to the viseme 1 to the viseme 16 in FIG. 7), and four co-pronunciation viseme parameters (namely, viseme parameters corresponding to the viseme 17 to the viseme 20 in FIG. 7).

Referring again to FIG. 9, the example mouth shape controls include 16 single-pronunciation mouth shape controls (namely, a mouth shape control 1 to a mouth shape control 16 shown in 902 in FIG. 9) and four co-pronunciation mouth shape controls (namely, a mouth shape control 17 to a mouth shape control 20 shown in 903 in FIG. 9).

For each set of viseme feature data, the terminal may automatically assign values to single-pronunciation mouth shape controls in the animation production interface of the terminal separately by using the single-pronunciation viseme parameters corresponding to the viseme feature data. In addition, the terminal may also automatically assign values to co-pronunciation mouth shape controls in the animation production interface of the terminal separately by using the co-pronunciation viseme parameters corresponding to the viseme feature data.

By automatically assigning values to the single-pronunciation mouth shape controls in the animation production interface separately by using the single-pronunciation viseme parameters corresponding to the viseme feature data, and by automatically assigning values to the co-pronunciation mouth shape controls in the animation production interface separately by using the co-pronunciation viseme parameters corresponding to the viseme feature data, the accuracy of value assignment for the mouth shapes can be improved, so that the generated mouth shape animation is more adapted to the target audio.

In one or more examples, the intensity information may include a horizontal intensity parameter and a vertical intensity parameter; the intensity control may include a horizontal intensity control and a vertical intensity control; and the assigning values to intensity controls in the animation production interface by using the intensity information corresponding to the viseme feature data may include: assigning a value to the horizontal intensity control in the animation production interface by using the horizontal intensity parameter corresponding to the viseme feature data; and assigning a value to the vertical intensity control in the animation production interface by using the vertical intensity parameter corresponding to the viseme feature data.

The horizontal intensity parameter may be a parameter for controlling a change intensity of a horizontal direction of a viseme. The vertical intensity parameter may be a parameter for controlling a change intensity of a vertical direction of a viseme.

It may be understood that the horizontal intensity parameter may be used for controlling a degree of relaxation of lips in a viseme, and the vertical intensity parameter may be used for controlling a degree of closure of a chin in the viseme.

Referring again to the example of FIG. 7, the intensity information may include a horizontal intensity parameter (namely, a viseme parameter corresponding to the lips in FIG. 7) and a vertical intensity parameter (namely, a viseme parameter corresponding to the chin in FIG. 7).

Referring again to the example of FIG. 9, the intensity controls shown in 901 in FIG. 9 may include a horizontal intensity control (namely, for controlling the change intensity of the lips of the viseme) and a vertical intensity control (namely, for controlling the change intensity of the chin of the viseme). As for the intensity controls shown in 904, 905, and 906 in FIG. 9, the horizontal intensity control and the vertical intensity control may have different assigned values, and the presented change intensities of the visemes also may be different, so that different mouth shapes can be formed.

For example, the terminal may automatically assign a value to the horizontal intensity control in the animation production interface of the terminal by using the horizontal intensity parameter corresponding to the viseme feature data. In addition, the terminal may also automatically assign a value to the vertical intensity control in the animation production interface of the terminal by using the vertical intensity parameter corresponding to the viseme feature data.

By automatically assigning values to the horizontal intensity controls in the animation production interface by using the horizontal intensity parameters corresponding to the viseme feature data and by automatically assigning values to the vertical intensity controls in the animation production interface by using the vertical intensity parameters corresponding to the viseme feature data, the accuracy of the intensity assignment can be improved, so that the generated mouth shape animation is more adapted to the target audio.

According to one or more arrangements, after generating a mouth shape animation corresponding to the target audio according to the mouth shape key frames respectively corresponding to the sets of viseme feature data, the method may further include: performing control parameter updating for at least one of the value-assigned mouth shape controls and the value-assigned intensity controls in response to a trigger operation for the mouth shape controls; and controlling, by using an updated control parameter, the virtual face to change.

For example, a user may perform a trigger operation on the mouth shape control, and the terminal may perform control parameter updating for at least one of the value-assigned mouth shape controls and the value-assigned intensity controls in response to the trigger operation for the mouth shape control. Further, the terminal may control, by using an updated control parameter, the virtual face to change, to obtain an updated mouth shape animation.

By performing the trigger operation on the mouth shape control, the control parameter updating can be further performed for at least one of the value-assigned mouth shape controls and the value-assigned intensity controls, and by controlling, by using the updated control parameter, the virtual face to change, so as to enable the generated mouth shape animation to be more realistic.

In one or more arrangements, each mouth shape control in the animation production interface may have a mapping relationship with a corresponding action unit; each action unit is used for controlling a corresponding region of the virtual face to produce a change; and the controlling, by using the value-assigned mouth shape controls and the value-assigned intensity controls, a virtual face to change, so as to generate a mouth shape key frame corresponding to the viseme feature data may include: determining, for an action unit mapped by each value-assigned mouth shape control, a target action parameter of the action unit according to an action intensity parameter of a matched intensity control; the matched intensity control being a value-assigned intensity control corresponding value-assigned mouth shape control; and controlling, according to the action unit having the target action parameter, the corresponding region of the virtual face to produce a change, so as to generate the mouth shape key frame corresponding to the viseme feature data.

The action intensity parameter may be a parameter of a value-assigned intensity control. It may be understood that, after a value is assigned to the intensity control in the animation production interface by using the intensity information corresponding to the viseme feature data, the action intensity parameter of the intensity control can be obtained. The target action parameter may be an action parameter for controlling an action unit to enable a corresponding region of a virtual face to produce a change.

For example, for the action unit mapped by each value-assigned mouth shape control, the terminal may determine, according to the action intensity parameter of the intensity control that matches the value-assigned mouth shape control, a target action parameter of the action unit mapped by the value-assigned mouth shape control. Further, the terminal may control, based on the action unit having the target action parameter, the corresponding region of the virtual face to produce a change, so as to generate the mouth shape key frame corresponding to the viseme feature data.

For each action unit mapped by each value-assigned mouth shape control, the terminal may directly use the action intensity parameter of the matched intensity control as the target action parameter of the action unit.

The viseme information corresponding to each set of viseme feature data may further include adjoint intensity information that affects a viseme. The terminal may determine, according to the action intensity parameter of the intensity control that matches the value-assigned mouth shape control and the adjoint intensity information, a target action parameter of the action unit mapped by the value-assigned mouth shape control. In this way, by determining the final target action parameter of the action unit by jointly using the adjoint intensity information and the action intensity parameter, the accuracy of the target action parameter can be further improved.

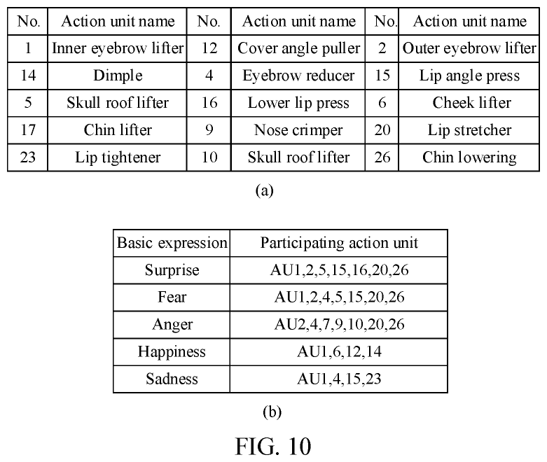

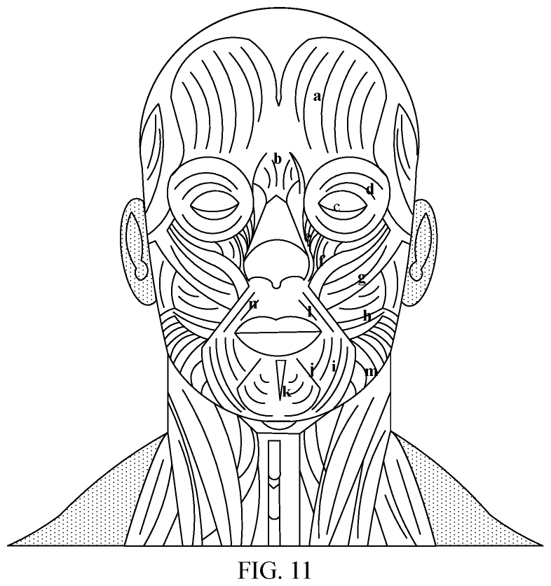

In the example of FIG. 10, FIG. 10(a) shows a part of an action unit (AU) used for controlling a corresponding region of a virtual face to produce a change. FIG. 10(b) shows action units respectively by five basic expressions (namely, surprise, fear, anger, happiness, and sadness). It may be understood that each expression may be generated by simultaneously controlling a plurality of action units. It may also be understood that each mouth shape key frame may also be generated by joint control by a plurality of action units.

As shown in FIG. 11, each action unit may be used for controlling a corresponding region (for example, a region a to a region n shown in FIG. 11) of a virtual face to produce a change. The terminal may control a corresponding region of the virtual face to produce a change, so as to generate a mouth shape key frame corresponding to the viseme feature data.

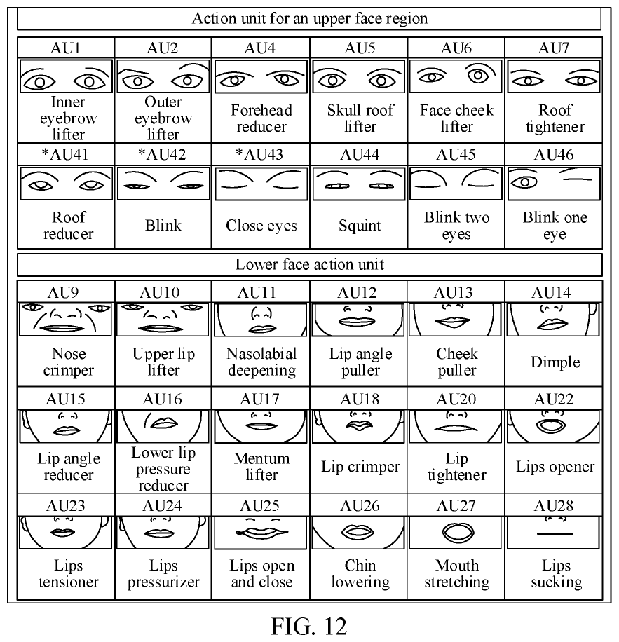

FIG. 12 illustrates basic action units. The basic action units may be grouped into action units corresponding to an upper face and action units corresponding to a lower face. The action units corresponding to the upper face may control the upper face of the virtual face to generate a corresponding change, and the action units corresponding to the lower face may control the lower face of the virtual face to generate a corresponding change.

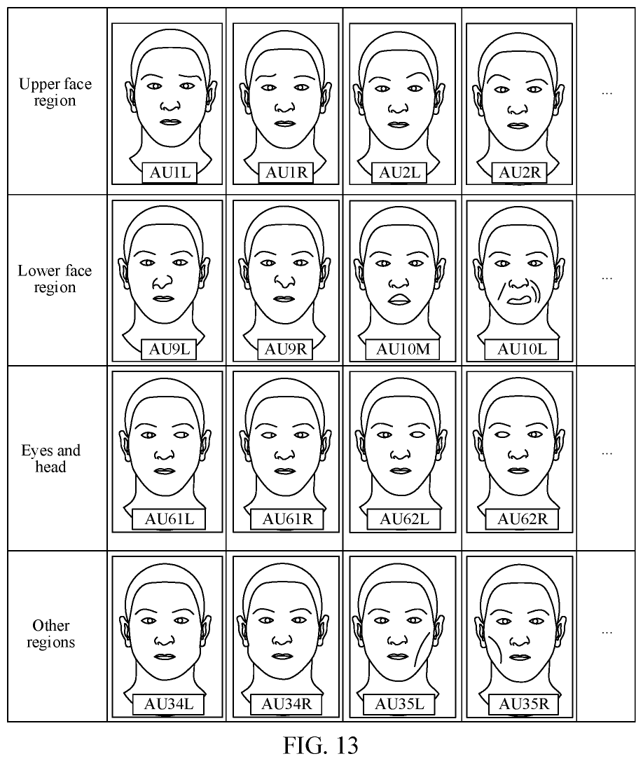

FIG. 13 illustrates additional action units. The additional action units may include an action unit for an upper face region, an action unit for a lower face region, an action unit for eyes and head, and an action unit for other regions, respectively. It may be understood that, based on the implementation of the basic action units shown in FIG. 12, more detailed control of the virtual face may be implemented by using the additional action units, so that a richer and more detailed mouth shape animation is generated.

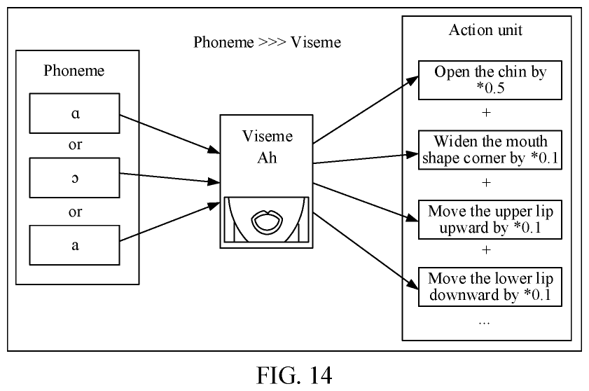

FIG. 14 illustrates a mapping relationship among a phoneme, a viseme, and an action unit. It may be understood that the viseme Ah may be obtained by superimposing action units such as opening the chin by 0.5, widening the mouth shape corner by 0.1, moving the upper lip upward by 0.1, and moving the lower lip by 0.1.

In the foregoing, for the action units mapped by each value-assigned mouth shape control, target action parameters of the action units can be determined according to the action intensity parameters of the matched intensity control, and further the corresponding region of the virtual face can be automatically controlled to produce a change according to the action units having the target action parameters, so that the accuracy of the generated mouth shape key frame can be improved and, additionally, the generation efficiency of the mouth shape animation can also be improved.

In one or more arrangements, the adjoint intensity information may include an initial animation parameter of the action unit; and the determining, for the action unit mapped by each value-assigned mouth shape control, the target action parameter of the action unit according to the adjoint intensity information and the action intensity parameter of the matched intensity control may include:
weighting, for the action unit mapped by each value-assigned mouth shape control, the action intensity parameter of the matched intensity control with the initial animation parameter of the action unit, to obtain the target action parameter of the action unit.

The initial animation parameter may be an animation parameter obtained after an action unit is initialized and assigned.

In some examples, for the action units mapped by each value-assigned mouth shape control, the terminal may obtain the initial animation parameters of the action units mapped by the value-assigned mouth shape control, and weight the action intensity parameters of the intensity control that matches the value-assigned mouth shape control with the initial animation parameters of the action units mapped by the value-assigned mouth shape control, to obtain the target action parameters of the action units.

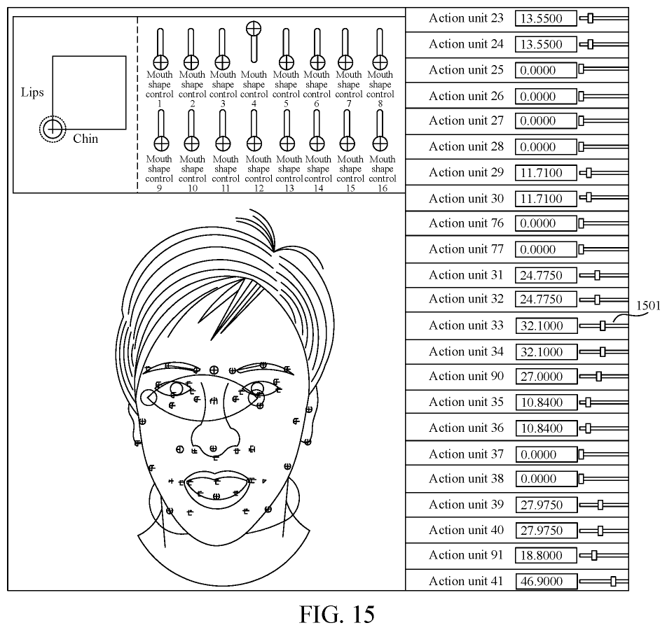

As shown in FIG. 15, in one example, after terminal assigns values to a mouth shape control, action units (that is, the action units shown in 1501 in FIG. 15) mapped by a mouth shape control 4 may be driven. It may be understood that visualized parameters corresponding to the action units shown in 1501 in FIG. 15 are the initial animation parameters. The terminal may weight an action intensity parameter of an intensity control that matches the mouth shape control 4 with the initial animation parameters of the action units mapped by the mouth shape control 4, to obtain target action parameters of the action units.

In the foregoing, for the action units mapped by each value-assigned mouth shape control, by weighting the action intensity parameter of the matched intensity control with the initial animation parameters of the action units, the target action parameters of the action units can be obtained, so that the corresponding regions of the virtual face can be controlled to produce a change more accurately according to the action units having the target action parameters, the accuracy of the generated mouth shape key frame can be improved, and therefore the generated mouth shape animation is more adapted to the target audio.

In one or more examples, the generating a mouth shape animation corresponding to the target audio according to the mouth shape key frames respectively corresponding to the sets of viseme feature data may further include: bonding and recording, for the mouth shape key frame corresponding to each set of viseme feature data, the mouth shape key frames corresponding to the viseme feature data and a timestamp corresponding to the viseme feature data, to obtain a record result corresponding to the mouth shape key frame; obtaining an animation playing curve corresponding to the target audio according to the record results respectively corresponding to the mouth shape key frames; and sequentially playing the mouth shape key frames according to the animation playing curve, to obtain a mouth shape animation corresponding to the target audio.

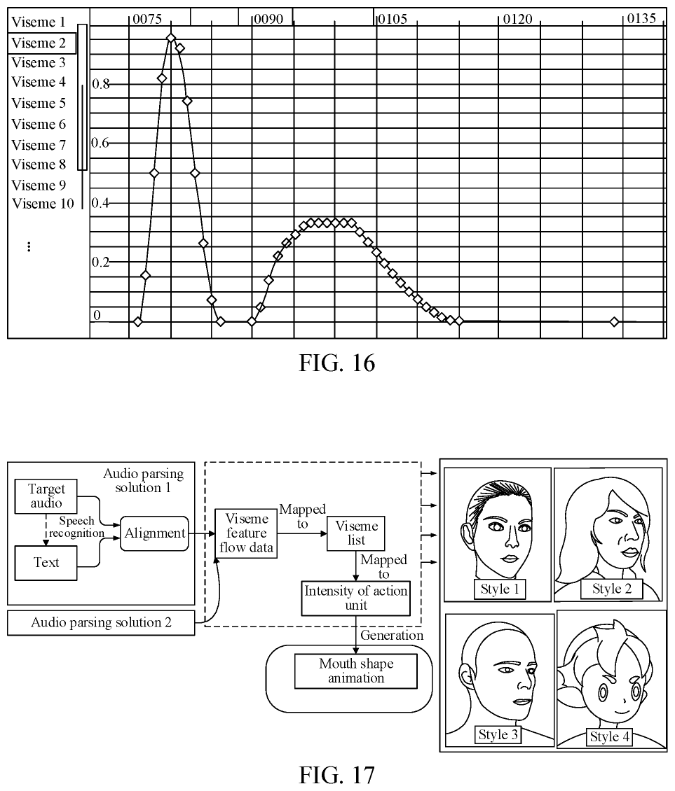

For example, for the mouth shape key frame corresponding to each set of viseme feature data, the terminal may bond and record the mouth shape key frames corresponding to the viseme feature data and a timestamp corresponding to the viseme feature data, to obtain a record result corresponding to the mouth shape key frame. The terminal may generate, according to the record results respectively corresponding to the mouth shape key frames, an animation playing curve corresponding to the target audio (as shown in FIG. 16, it may be understood that, an ordinate corresponding to the animation playing curve is the adjoint intensity information, and an abscissa corresponding to the animation playing curve is a timestamp), and store the animation playing curve. Further, the terminal may sequentially play the mouth shape key frames according to the animation playing curve, to obtain a mouth shape animation corresponding to the target audio.

In some examples, the viseme information corresponding to each set of viseme feature data may further include adjoint intensity information that affects a viseme. The terminal may control, according to the viseme information including the adjoint intensity information and the intensity information corresponding to each set of viseme feature data, the virtual face to change, so as to generate the mouth shape animation corresponding to the target audio.

In the foregoing, by binding and recording the mouth shape key frames corresponding to the viseme feature data and the timestamps corresponding to the viseme feature data, an animation playing curve corresponding to the target audio may be generated, so that the mouth shape key frames are played sequentially according to the animation playing curve, to obtain the mouth shape animation corresponding to the target audio, and the generated mouth shape animation record is stored, for playing later when needed.

As shown in the example of FIG. 17, the terminal may perform feature analysis on a target audio by using an audio parsing solution 1 or an audio parsing solution 2, to obtain viseme feature flow data. It may be understood that the audio parsing solution 1 may include performing feature analysis on the target audio in combination with a text, to obtain the viseme feature flow data. The audio parsing solution 2 includes independently performing feature analysis on the target audio, to obtain the viseme feature flow data. For each set of viseme feature data in the viseme feature flow data, the terminal may separately map viseme fields in the viseme feature data with visemes in a preset viseme list, to obtain viseme information corresponding to the viseme feature data, and parse intensity fields in the viseme feature data, to obtain the intensity information corresponding to the viseme feature data. Further, the terminal may control, by using the viseme information and the intensity information, the virtual face to produce a change, so as to generate a mouth shape animation corresponding to the target audio. It may be understood that, the mouth shape animation generation method of this application is applicable to virtual objects of various styles (for example, virtual objects corresponding to a style 1 to a style 4 in FIG. 17).

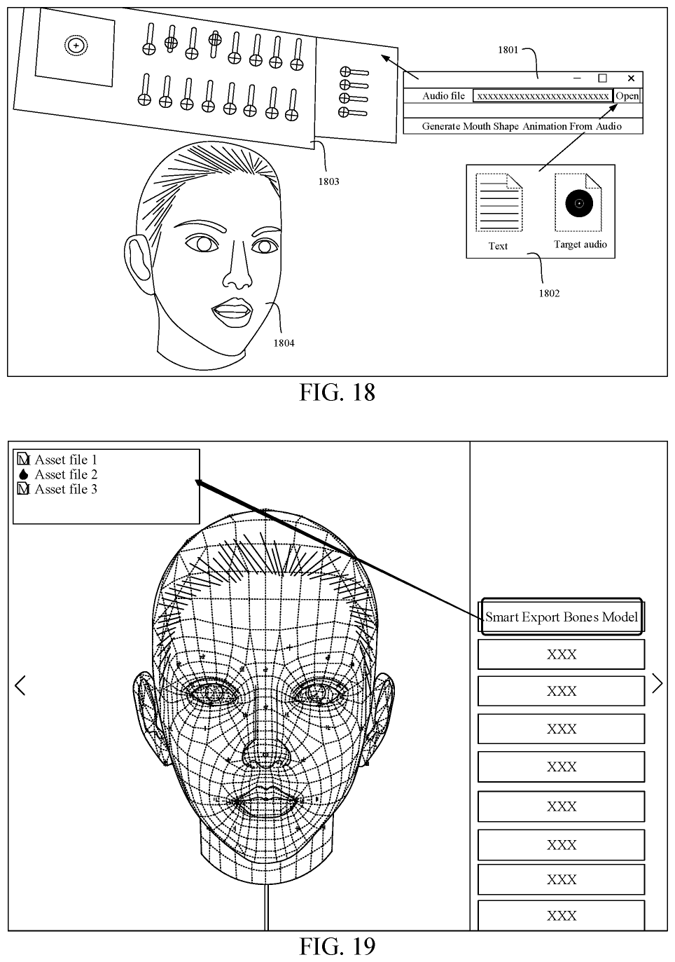

As shown in the example of FIG. 18, a user may select a target audio and a corresponding text (namely, a target audio and a text in a multimedia storage region 1802) in the audio selection region 1801 of the animation production interface, so that the feature analysis is performed on the target audio with the text, and the accuracy of the feature analysis is improved. A user may click on the button “Generate Mouth Shape Animation From Audio”, to trigger to assign values to mouth shape controls and intensity controls in a control region 1803, so as to automatically drive to generate a mouth shape animation 1804.

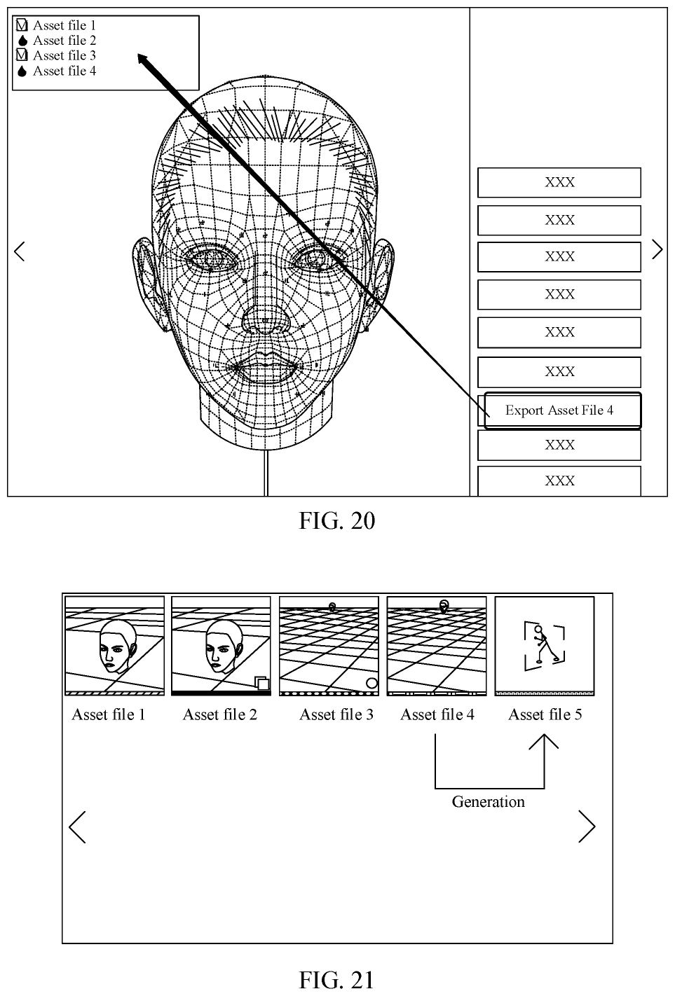

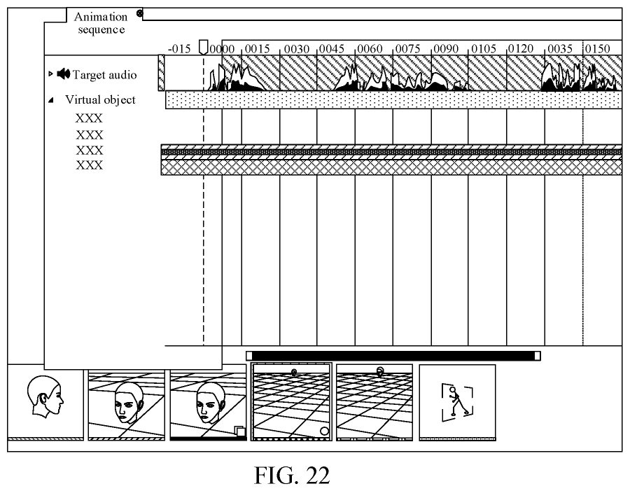

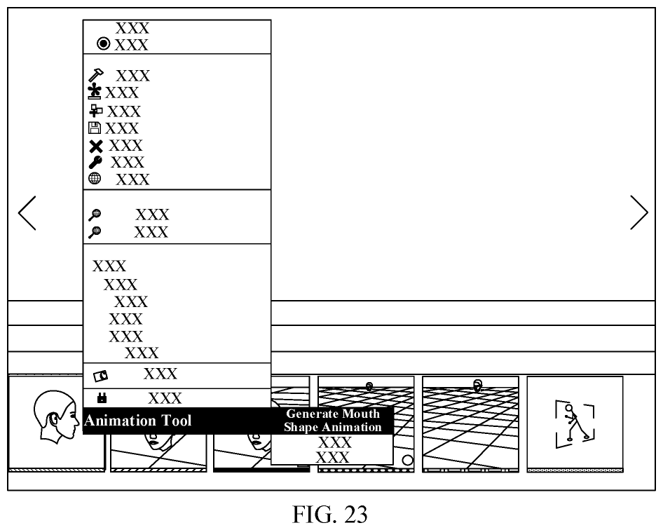

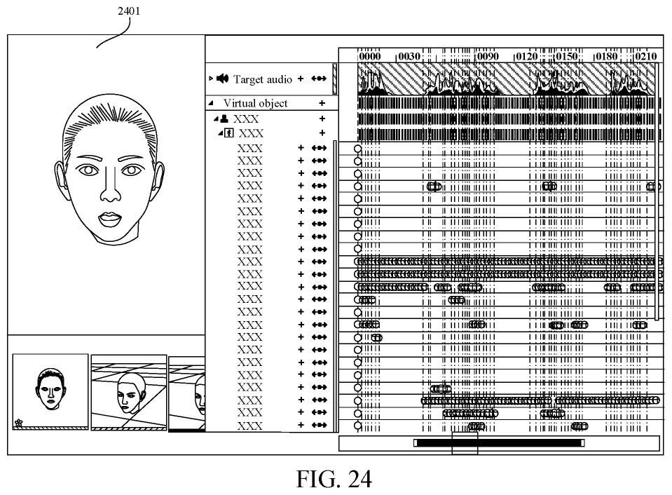

In an example as shown in FIG. 19, a user may click on the button “Smart Export Bones Model” in the animation production interface, and the terminal may automatically generate an asset file 1, an asset file 2, and an asset file 3 for generating a mouth shape animation in response to the trigger operation on the button “Smart Export Bones Model”. Further, as shown in FIG. 20, a user may click on the button “Export Asset File 4” in the animation production interface, and the terminal may automatically generate an asset file 4 for generating a mouth shape animation in response to the trigger operation on the button “Export Asset File 4”. As shown in FIG. 21, the terminal may generate an asset file 5 based on the asset file 4. As shown in FIG. 22, the terminal may create an initial animation sequence according to the asset file 1 to the asset file 5, and add a virtual object and target audio of a corresponding style to the created initial animation sequence. Further, as shown in FIG. 23, a user may click on the button “Generate Mouth Shape Animation” in “Animation Tool” in the animation production interface, so that the terminal automatically generates a mouth shape animation, to finally obtain a mouth shape animation shown in an animation display region 2401 in FIG. 24. It may be understood that the initial animation sequence does not have a mouth shape, and the finally generated mouth shape animation has a mouth shape corresponding to the target audio. The asset file 1, the asset file 2, and the asset file 3 are assets such as a character model and bones needed for generating a mouth shape animation. The asset file 4 is an expression asset needed for generating a mouth shape animation. The asset file 5 is a gesture asset needed for generating a mouth shape animation.

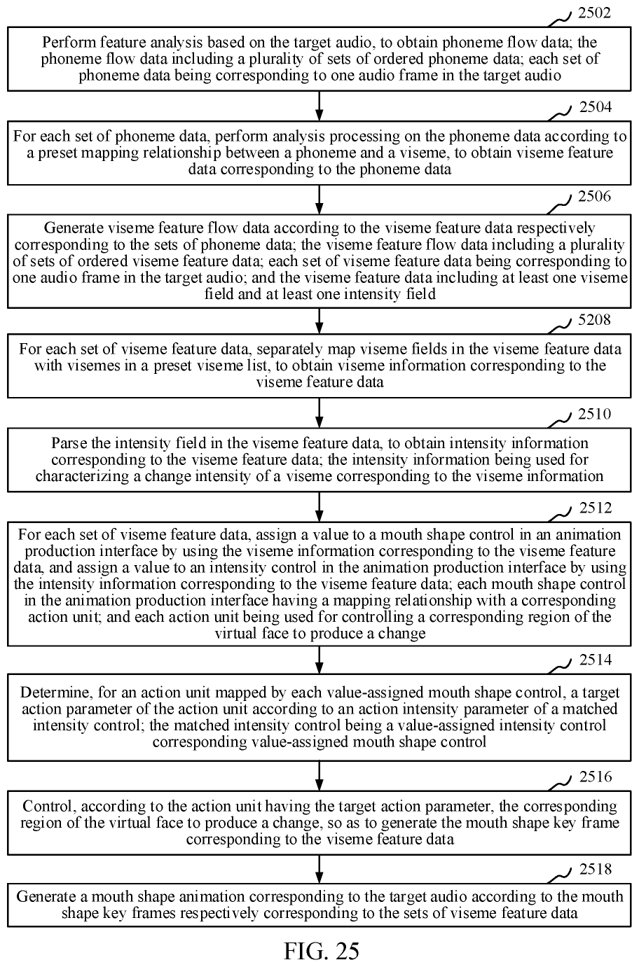

As shown in FIG. 25, in an example, a mouth shape animation generation method is provided. For example, in this example, the method is applied to the terminal 102 in FIG. 1. The method includes the following steps:
Step 2502: Perform the feature analysis based on the target audio, to obtain phoneme flow data. The phoneme flow data includes a plurality of sets of ordered phoneme data. Each set of phoneme data corresponds to one audio frame in the target audio.
Step 2504: For each set of phoneme data, perform analysis processing on the phoneme data according to a preset mapping relationship between a phoneme and a viseme, to obtain viseme feature data corresponding to the phoneme data.
Step 2506: Generate viseme feature flow data according to the viseme feature data respectively corresponding to the sets of phoneme data. The viseme feature flow data includes a plurality of sets of ordered viseme feature data. Each set of viseme feature data being corresponding to one audio frame in the target audio. The viseme feature data includes at least one viseme field and at least one intensity field.
Step 2508: For each set of viseme feature data, separately map viseme fields in the viseme feature data with visemes in a preset viseme list, to obtain viseme information corresponding to the viseme feature data.
Step 2510: Parse the intensity field in the viseme feature data, to obtain the intensity information corresponding to the viseme feature data. The intensity information is used for characterizing a change intensity of a viseme corresponding to the viseme information.
Step 2512: For each set of viseme feature data, assign values to mouth shape controls in an animation production interface by using the viseme information corresponding to the viseme feature data, and assign values to intensity controls in the animation production interface by using the intensity information corresponding to the viseme feature data. Each mouth shape control in the animation production interface has a mapping relationship with a corresponding action unit; and each action unit being used for controlling a corresponding region of the virtual face to produce a change.
Step 2514: For an action unit mapped by each value-assigned mouth shape control, determine a target action parameter of the action unit according to an action intensity parameter of a matched intensity control. The matched intensity control being a value-assigned intensity control corresponding value-assigned mouth shape control.
Step 2516: Control, according to the action unit having the target action parameter, the corresponding region of the virtual face to produce a change, so as to generate the mouth shape key frame corresponding to the viseme feature data.
Step 2518: Generate a mouth shape animation corresponding to the target audio according to the mouth shape key frames respectively corresponding to the sets of viseme feature data.

An application scenario may also be provided. For example, the application scenario may be applied to the mouth shape animation generation method. Specifically, the mouth shape animation generation method may be applied to a mouth shape animation generation scenario of a virtual object in a game. The terminal can perform feature analysis based on a target game audio, to obtain phoneme flow data. The phoneme flow data may include a plurality of sets of ordered phoneme data. Each set of phoneme data may correspond to one audio frame in the target game audio. For each set of phoneme data, analysis processing may be performed on the phoneme data according to a preset mapping relationship between a phoneme and a viseme, to obtain viseme feature data corresponding to the phoneme data. Viseme feature flow data may then be generated according to the viseme feature data respectively corresponding to the sets of phoneme data. The viseme feature flow data may include a plurality of sets of ordered viseme feature data. Each set of viseme feature data may correspond to one audio frame in the target game audio. The viseme feature data may include at least one viseme field and at least one intensity field.

For each set of viseme feature data, the terminal may separately map viseme fields in the viseme feature data with visemes in a preset viseme list, to obtain viseme information corresponding to the viseme feature data. The intensity field in the viseme feature data may be parsed, to obtain intensity information corresponding to the viseme feature data. The intensity information may be used for characterizing a change intensity of a viseme corresponding to the viseme information. For each set of viseme feature data, a value may be assigned to a mouth shape control in an animation production interface by using the viseme information corresponding to the viseme feature data, and a value may be assigned to an intensity control in the animation production interface by using the intensity information corresponding to the viseme feature data. Each mouth shape control in the animation production interface may have a mapping relationship with a corresponding action unit. Each action unit may be used for controlling a corresponding region of the virtual face of the game object to produce a change.

For an action unit mapped by each value-assigned mouth shape control, the terminal may determine a target action parameter of the action unit according to an action intensity parameter of a matched intensity control. The matched intensity control may be a value-assigned intensity control corresponding value-assigned mouth shape control. According to the action unit having the target action parameter, the corresponding region of the virtual face of the game object may be controlled to produce a change, so as to generate the mouth shape key frame corresponding to the viseme feature data. A game mouth shape animation corresponding to the target game audio may be generated according to the mouth shape key frames respectively corresponding to the sets of viseme feature data. By using the mouth shape animation generation method of this application, the efficiency of generating a mouth shape animation in a game scenario can be improved.

The mouth shape animation generation method may also be applied to scenarios such as film and television animation and Virtual Reality (VR) animation. It may be understood that, in scenarios such as film and television animation and VR animation, generation of a mouth shape animation for a virtual object may also be involved. By using the mouth shape animation generation method of this application, the generation efficiency of mouth shape animation in scenarios such as film and television animation and VR animation can be improved. The mouth shape animation generation method of this application can also be applied to a game scenario. In other words, a game player may select a corresponding virtual image, and further the selected virtual image is driven to automatically generate a corresponding mouth shape animation based on a voice input by a game player.

It is to be understood that, although the steps are displayed sequentially according to the illustrated flowcharts, these steps might not necessarily performed sequentially according to the sequence. Unless otherwise explicitly specified, execution of the steps is not strictly limited, and these steps may be performed in other sequences. Moreover, at least some of the steps may include a plurality of sub-steps or a plurality of stages. The sub-steps or stages are not necessarily performed at the same moment but may be performed at different moments. Execution of the sub-steps or stages is not necessarily sequentially performed, but may be performed alternately with other steps or at least some of sub-steps or stages of other steps.

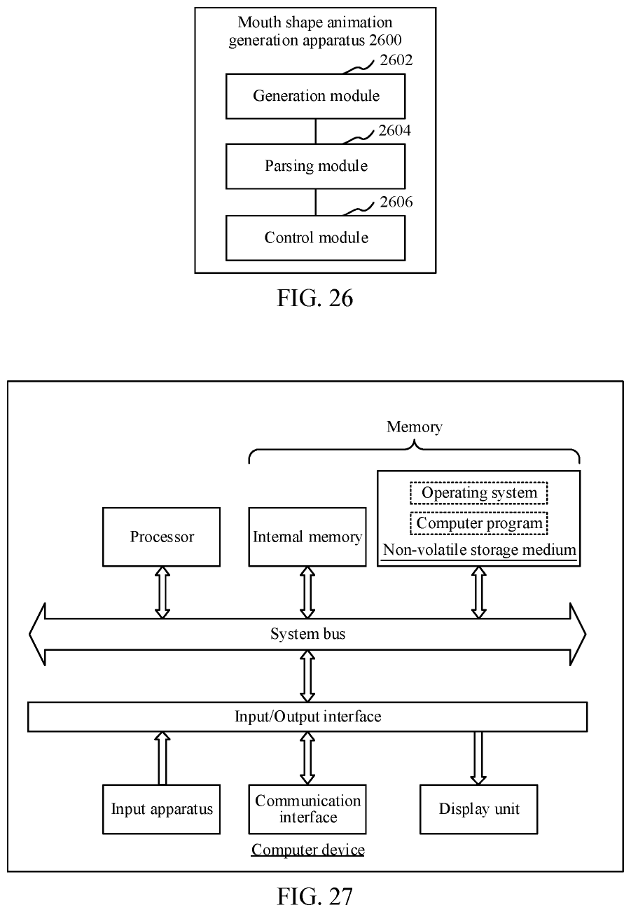

In the example of FIG. 26, a mouth shape animation generation apparatus 2600 is provided. The apparatus may use a software module or a hardware module, or a combination of the above, to become part of a computer device. The apparatus may include:
a generation module 2602, configured to perform feature analysis based on a target audio, to generate viseme feature flow data; the viseme feature flow data including a plurality of sets of ordered viseme feature data; each set of viseme feature data corresponding to one audio frame in the target audio;
a parsing module 2604, configured to separately parse each set of viseme feature data, to obtain viseme information and intensity information corresponding to the viseme feature data; the intensity information being used for characterizing a change intensity of a viseme corresponding to the viseme information; and
a control module 2606, configured to control, according to the viseme information and the intensity information corresponding to the sets of viseme feature data, a virtual face to change, so as to generate a mouth shape animation corresponding to the target audio.

In one or more examples, the generation module 2602 may be further configured to perform the feature analysis based on the target audio, to obtain phoneme flow data; the phoneme flow data including a plurality of sets of ordered phoneme data; each set of phoneme data being corresponding to one audio frame in the target audio; for each set of phoneme data, perform analysis processing on the phoneme data according to a preset mapping relationship between a phoneme and a viseme, to obtain viseme feature data corresponding to the phoneme data; and generate viseme feature flow data according to the viseme feature data respectively corresponding to the sets of phoneme data.

In one or more example, the generation module 2602 may be further configured to determine a text matching the target audio; and perform alignment processing on the target audio and the text, and generate the phoneme flow data by parsing according to an alignment processing result.

In one or more example, the generation module 2602 may be further configured to obtain reference phoneme flow data corresponding to the text; perform speech recognition on the target audio, to obtain initial phoneme flow data; and perform alignment processing on the initial phoneme flow data and the reference phoneme flow data, and adjust a phoneme in the initial phoneme flow data by using the alignment processing result, to obtain the phoneme flow data corresponding to the target audio.

In one or more example, the viseme feature data may include at least one viseme field and at least one intensity field. Accordingly, the parsing module 2604 may be further configured to: for each set of viseme feature data, separately map viseme fields in the viseme feature data with visemes in a preset viseme list, to obtain viseme information corresponding to the viseme feature data; and parse the intensity field in the viseme feature data, to obtain the intensity information corresponding to the viseme feature data.

In one or more example, the viseme field may include at least one single-pronunciation viseme field and at least one co-pronunciation viseme field; the visemes in the viseme list may include at least one single-pronunciation viseme and at least one co-pronunciation viseme. The parsing module 2604 may be further configured to, for each set of viseme feature data, separately map single-pronunciation viseme fields in the viseme feature data with single-pronunciation visemes in the viseme list; and separately map co-pronunciation viseme fields in the viseme feature data with co-pronunciation visemes in the viseme list, to obtain viseme information corresponding to the viseme feature data.

In one or more example, the control module 2606 may be further configured to: for each set of viseme feature data, assign values to mouth shape controls in an animation production interface by using the viseme information corresponding to the viseme feature data, and assign values to intensity controls in the animation production interface by using the intensity information corresponding to the viseme feature data; control, by using the value-assigned mouth shape controls and the value-assigned intensity controls, a virtual face to change, so as to generate a mouth shape key frame corresponding to the viseme feature data; and generate a mouth shape animation corresponding to the target audio according to the mouth shape key frames respectively corresponding to the sets of viseme feature data.

In one or more example, the viseme information may include at least one single-pronunciation viseme parameter and at least one co-pronunciation viseme parameter. The mouth shape controls may include at least one single-pronunciation mouth shape control and at least one co-pronunciation mouth shape control. The control module 2606 may be further configured to: for each set of viseme feature data, separately assign values to single-pronunciation mouth shape controls in the animation production interface by using the single-pronunciation viseme parameters corresponding to the viseme feature data; and separately assign values to co-pronunciation mouth shape controls in the animation production interface by using the co-pronunciation viseme parameters corresponding to the viseme feature data.

In one or more example, the intensity information may include a horizontal intensity parameter and a vertical intensity parameter. The intensity control may include a horizontal intensity control and a vertical intensity control. The control module 2606 may be further configured to assign a value to the horizontal intensity control in the animation production interface by using the horizontal intensity parameter corresponding to the viseme feature data; and assign a value to the vertical intensity control in the animation production interface by using the vertical intensity parameter corresponding to the viseme feature data.

In one or more example, the control module 2606 may be further configured to perform control parameter updating for at least one of the value-assigned mouth shape controls and the value-assigned intensity controls in response to a trigger operation for the mouth shape controls; and control, by using an updated control parameter, the virtual face to change.

In one or more example, each mouth shape control in the animation production interface may have a mapping relationship with a corresponding action unit. Each action unit may be used for controlling a corresponding region of the virtual face to produce a change. The control module 2606 may be further configured to: for an action unit mapped by each value-assigned mouth shape control, determine a target action parameter of the action unit according to an action intensity parameter of a matched intensity control; the matched intensity control being a value-assigned intensity control corresponding value-assigned mouth shape control; and control, according to the action unit having the target action parameter, the corresponding region of the virtual face to produce a change, so as to generate the mouth shape key frame corresponding to the viseme feature data.

In one or more example, the viseme information corresponding to each set of viseme feature data also may include the adjoint intensity information that affects the viseme corresponding to the viseme information. The control module 2606 may be further configured to: for the action unit mapped by each value-assigned mouth shape control, determine the target action parameter of the action unit according to the adjoint intensity information and the action intensity parameter of the matched intensity control.

In one or more example, the control module 2606 may be further configured to: for the action unit mapped by each value-assigned mouth shape control, weight the action intensity parameter of the matched intensity control with the initial animation parameter of the action unit, to obtain the target action parameter of the action unit.

In one or more example, the control module 2606 may be further configured to: for the mouth shape key frame corresponding to each set of viseme feature data, bond and record the mouth shape key frames corresponding to the viseme feature data and a timestamp corresponding to the viseme feature data, to obtain a record result corresponding to the mouth shape key frame; obtain an animation playing curve corresponding to the target audio according to the record results respectively corresponding to the mouth shape key frames; and sequentially play the mouth shape key frames according to the animation playing curve, to obtain a mouth shape animation corresponding to the target audio.

The mouth shape animation generation apparatus may perform feature analysis based on the target audio, to generate viseme feature flow data. The viseme feature flow data may include a plurality of sets of ordered viseme feature data, and each set of viseme feature data corresponds to one frame of audio frame in the target audio. By separately parsing each set of viseme feature data, the viseme information and the intensity information corresponding to the viseme feature data can be obtained, and the intensity information is used for characterizing a change intensity of the viseme corresponding to the viseme information. The viseme information may be used for indicating a corresponding viseme and the intensity information may be used for indicating a degree of relaxation of the corresponding viseme. Therefore, according to the viseme information and the intensity information corresponding to the sets of viseme feature data, the virtual face can be controlled to generate a corresponding change, so as to automatically generate the mouth shape animation corresponding to the target audio. Compared with the conventional method of manually producing a mouth shape animation, in this application, by parsing the target audio into viseme feature flow data capable of driving the virtual face to produce a change, the virtual face is automatically driven by the viseme feature flow data to produce a change, so as to automatically generate the mouth shape animation corresponding to the target audio, thereby shortening the generation time of the mouth shape animation and improving the generation efficiency of the mouth shape animation.

The modules in the mouth shape animation generation apparatus can be implemented in whole or in part by software, hardware, and a combination thereof. The foregoing modules can be embedded in or independent from a processor in computer device in form of hardware, or can be stored in a memory in computer device in form of software, so that the processor invokes and performs operations corresponding to the foregoing modules.

In one or more example, a computer device may be provided. The computer device may be a terminal, and an internal structure diagram thereof may be shown in FIG. 27. The computer device may include a processor, a memory, an input/output interface, a communication interface, a display unit, and an input apparatus. The processor, the memory, and the input/output interface may be connected through a system bus, and the communication interface, the display unit, and the input apparatus may be connected to the system bus through the input/output interface. The processor of the computer device may be configured to provide computation and control capabilities. The memory of the computer device may include a non-volatile storage medium and an internal memory. The non-volatile storage medium may store an operating system and computer-readable instructions. The internal memory may provide an environment for the operation of an operating system and computer-readable instructions in the non-volatile storage medium. The input/output interface of the computer device may be used for exchanging information between the processor and an external device. The communication interface of the computer device may be used for wired or wireless communication with an external terminal. The wireless mode may be implemented through WiFi, a mobile cellular network, Near Field Communication (NFC), or other technologies. The computer-readable instructions, when executed by a processor, implement a mouth shape animation generation method. The display unit of the computer device may be configured to form a visualized image, and may be a display screen, a projection device or a virtual reality imaging apparatus, the display screen may be a liquid crystal display screen or an electronic ink display screen, and the input apparatus of the computer device may be a touch layer covered on the display screen, or a key, a trackball or a touch pad provided on a housing of the computer device, or an external keyboard, touch pad or mouse, or the like.

A person skilled in the art may understand that, the structure shown in FIG. 27 is merely an example block diagram of a partial structure according to one or more aspects described herein, and does not constitute a limitation to the computer device. For example, the computer device may include more components or fewer components than those shown in the figure, or some components may be combined, or a different component deployment may be used.

In one or more example, a computer device may be further provided, including a memory and one or more processors, the memory storing a computer-readable instructions, and the one or more processors, when executing the computer-readable instructions, may implement the steps in the foregoing aspects.

In one or more example, one or more computer-readable storage media may be provided, storing computer-readable instructions, and the computer-readable instructions, when executed by one or more processors, may implement the steps in the foregoing aspects.

In one or more example, a computer program product may be provided, including computer-readable instructions, and the computer-readable instructions, when executed by one or more processors, implementing the steps in the foregoing aspects.

The user information (including, but not limited to, user equipment information, user personal information, or the like) and data (including, but not limited to, data for analysis, stored data, displayed data, or the like) described herein may be all information or data authorized by the user or fully authorized by all parties, and the collection, use, and processing of related data need to comply with relevant laws, regulations, and standards of relevant countries and regions.

A person of ordinary skill in the art may understand that all or some of procedures of the method in the foregoing embodiments may be implemented by a computer program instructing relevant hardware. The computer-readable instructions may be stored in a non-volatile computer-readable storage medium. When the computer-readable instructions are executed, the procedures of the embodiments of the foregoing methods may be implemented. References to the memory, the storage, the database, or other medium used in the embodiments provided in this application may all include at least one of a non-volatile or a volatile memory. The non-volatile memory may include a Read-Only Memory (ROM), a tape, a floppy disk, a flash memory, optical memory, or the like. The volatile memory may be a Random Access Memory (RAM) serving as an external cache. By way of illustration but not limitation, the RAM may take a plurality of forms, such as a Static Random Access Memory (SRAM), a Dynamic Random Access Memory (DRAM), or the like.

One or more of technical features described herein may be combined. For conciseness, not all possible combinations of the technical features are described. However, the combinations of these technical features shall be considered as falling within the scope recorded by this specification provided that no conflict exists.

The foregoing aspects only describe various implementations, which are described in detail, but are not limited to these examples. It should be noted that for a person of ordinary skill in the art, several transformations and improvements can be made without departing from the idea described herein. These transformations and improvements encompassed within this disclosure.

What is claimed is:

1. A mouth shape animation generation method, executed by a computing device having a processor, the method comprising:
performing feature analysis based on a target audio, to generate viseme feature flow data, the viseme feature flow data comprising a plurality of sets of ordered viseme feature data, each set of viseme feature data corresponding to one audio frame in the target audio, respectively;
separately parsing each set of viseme feature data, to obtain viseme information and intensity information corresponding to the respective set of viseme feature data, the intensity characterizing a change intensity of a viseme corresponding to the viseme information; and
controlling, according to the viseme information and the intensity information corresponding to the sets of viseme feature data, a virtual face to change, so as to generate a mouth shape animation corresponding to the target audio.

2. The method according to claim 1, wherein the performing feature analysis based on a target audio, to generate viseme feature flow data, comprises:
performing the feature analysis based on the target audio, to obtain phoneme flow data, the phoneme flow data comprising a plurality of sets of ordered phoneme data, each set of phoneme data corresponding to one audio frame in the target audio respectively;
for each set of phoneme data, performing analysis processing on the respective set of phoneme data according to a preset mapping relationship between a phoneme and a viseme, to obtain the viseme feature data corresponding to the phoneme data; and
generating the viseme feature flow data according to the viseme feature data respectively corresponding to the sets of phoneme data.

3. The method according to claim 2, wherein the performing the feature analysis based on the target audio, to obtain phoneme flow data, further comprises:
determining a text matching the target audio; and
performing alignment processing on the target audio and the text, and generating the phoneme flow data by parsing according to an alignment processing result.

4. The method according to claim 3, wherein the performing alignment processing on the target audio and the text, and generating the phoneme flow data by parsing according to an alignment processing result, comprises:
obtaining reference phoneme flow data corresponding to the text;
performing speech recognition on the target audio, to obtain initial phoneme flow data; and
performing alignment processing on the initial phoneme flow data and the reference phoneme flow data, and adjusting a phoneme in the initial phoneme flow data by using the alignment processing result, to obtain the phoneme flow data corresponding to the target audio.

5. The method according to claim 1, wherein the viseme feature data comprises at least one viseme field and at least one intensity field; and
the separately parsing each set of viseme feature data, to obtain viseme information and intensity information corresponding to the viseme feature data comprises:
separately mapping, for each set of viseme feature data, viseme fields in the viseme feature data with visemes in a preset viseme list according to a preset mapping relationship between a viseme field and a viseme, to obtain the viseme information corresponding to the viseme feature data; and
parsing the intensity field in the viseme feature data, to obtain the intensity information corresponding to the viseme feature data.

6. The method according to claim 5, wherein the viseme field comprises at least one single-pronunciation viseme field and at least one co-pronunciation viseme field, the visemes in the viseme list comprise at least one single-pronunciation viseme and at least one co-pronunciation viseme; and
the separately mapping, for each set of viseme feature data, viseme fields in the viseme feature data with visemes in a preset viseme list according to a preset mapping relationship between a viseme field and a viseme, to obtain the viseme information corresponding to the viseme feature data comprises:
separately mapping, for each set of viseme feature data, single-pronunciation viseme fields in the viseme feature data with single-pronunciation visemes in the viseme list according to a preset mapping relationship between a single-pronunciation viseme field and a single-pronunciation viseme; and
separately mapping co-pronunciation viseme fields in the viseme feature data with co-pronunciation visemes in the viseme list according to a preset mapping relationship between a co-pronunciation viseme field and a co-pronunciation viseme, to obtain the viseme information corresponding to the viseme feature data.

7. The method according to claim 1, wherein the controlling, according to the viseme information and the intensity information corresponding to the sets of viseme feature data, a virtual face to change, so as to generate a mouth shape animation corresponding to the target audio, comprises:
assigning, for each set of viseme feature data, values to mouth shape controls in an animation production interface by using the viseme information corresponding to the viseme feature data, and assigning values to intensity controls in the animation production interface by using the intensity information corresponding to the viseme feature data;
controlling, by using the value-assigned mouth shape controls and the value-assigned intensity controls, a virtual face to change, so as to generate a mouth shape key frame corresponding to the viseme feature data; and
generating a mouth shape animation corresponding to the target audio according to the mouth shape key frames respectively corresponding to the sets of viseme feature data.

8. The method according to claim 7, wherein the viseme information comprises at least one single-pronunciation viseme parameter and at least one co-pronunciation viseme parameter, the mouth shape controls comprising at least one single-pronunciation mouth shape control and at least one co-pronunciation mouth shape control; and
the assigning, for each set of viseme feature data, values to mouth shape controls in an animation production interface by using the viseme information corresponding to the viseme feature data comprises:
separately assigning, for each set of viseme feature data, values to single-pronunciation mouth shape controls in the animation production interface by using the single-pronunciation viseme parameters corresponding to the respective set viseme feature data; and
separately assigning values to co-pronunciation mouth shape controls in the animation production interface by using the co-pronunciation viseme parameters corresponding to the viseme feature data.

9. The method according to claim 7, wherein the intensity information comprises a horizontal intensity parameter and a vertical intensity parameter, the intensity control comprising a horizontal intensity control and a vertical intensity control; and
the assigning values to intensity controls in the animation production interface by using the intensity information corresponding to the viseme feature data comprises:
assigning a value to the horizontal intensity control in the animation production interface by using the horizontal intensity parameter corresponding to the viseme feature data; and
assigning a value to the vertical intensity control in the animation production interface by using the vertical intensity parameter corresponding to the viseme feature data.

10. The method according to claim 7, wherein after generating a mouth shape animation corresponding to the target audio according to the mouth shape key frames respectively corresponding to the sets of viseme feature data, the method further comprises:
performing control parameter updating for at least one of the value-assigned mouth shape controls and the value-assigned intensity controls in response to a trigger operation for the mouth shape controls; and
controlling, by using an updated control parameter, the virtual face to change.

11. The method according to claim 7, wherein each mouth shape control in the animation production interface has a mapping relationship with a corresponding action unit, each action unit is used for controlling a corresponding region of the virtual face to produce a change; and
the controlling, by using the value-assigned mouth shape controls and the value-assigned intensity controls, a virtual face to change, so as to generate a mouth shape key frame corresponding to the viseme feature data, comprises:
determining, for an action unit mapped by each value-assigned mouth shape control, a target action parameter of the action unit according to an action intensity parameter of a matched intensity control, the matched intensity control being a value-assigned intensity control corresponding to the value-assigned mouth shape control; and
controlling, according to the action unit having the target action parameter, the corresponding region of the virtual face to produce a change, so as to generate the mouth shape key frame corresponding to the viseme feature data.

12. The method according to claim 11, wherein the viseme information corresponding to each set of viseme feature data further comprises adjoint intensity information that affects the viseme corresponding to the viseme information; and
the determining, for an action unit mapped by each value-assigned mouth shape control, a target action parameter of the action unit according to an action intensity parameter of a matched intensity control comprises:
determining, for the action unit mapped by each value-assigned mouth shape control, the target action parameter of the action unit according to the adjoint intensity information and the action intensity parameter of the matched intensity control.

13. The method according to claim 12, wherein the adjoint intensity information comprises an initial animation parameter of the action unit; and
wherein the determining, for the action unit mapped by each value-assigned mouth shape control, the target action parameter of the action unit according to the adjoint intensity information and the action intensity parameter of the matched intensity control comprises:
weighting, for the action unit mapped by each value-assigned mouth shape control, the action intensity parameter of the matched intensity control with the initial animation parameter of the action unit, to obtain the target action parameter of the action unit.

14. The method according to claim 7, wherein the generating a mouth shape animation corresponding to the target audio according to the mouth shape key frames respectively corresponding to the sets of viseme feature data comprises:
bonding and recording, for the mouth shape key frame corresponding to each set of viseme feature data, the mouth shape key frame corresponding to the viseme feature data and a timestamp corresponding to the viseme feature data, to obtain a record result corresponding to the mouth shape key frame;
obtaining an animation playing curve corresponding to the target audio according to the record results respectively corresponding to the mouth shape key frames; and
sequentially playing the mouth shape key frames according to the animation playing curve, to obtain a mouth shape animation corresponding to the target audio.

15. A mouth shape animation generation apparatus, comprising:
a generation module, configured to perform feature analysis based on a target audio to generate viseme feature flow data, the viseme feature flow data comprising a plurality of sets of ordered viseme feature data, each set of viseme feature data corresponding to one audio frame in the target audio;
a parsing module, configured to separately parse each set of viseme feature data to obtain viseme information and intensity information corresponding to the respective set of viseme feature data, the intensity information being used for characterizing a change intensity of a viseme corresponding to the viseme information; and
a control module, configured to control, according to the viseme information and the intensity information corresponding to the sets of viseme feature data, a virtual face to change, so as to generate a mouth shape animation corresponding to the target audio.

16. The mouth shape animation generation apparatus according to claim 15, wherein the generation module is configured to perform the feature analysis based on a target audio by:
performing the feature analysis based on the target audio, to obtain phoneme flow data, the phoneme flow data comprising a plurality of sets of ordered phoneme data, each set of phoneme data corresponding to one audio frame in the target audio respectively;
for each set of phoneme data, performing analysis processing on the respective set of phoneme data according to a preset mapping relationship between a phoneme and a viseme, to obtain the viseme feature data corresponding to the phoneme data; and
generating the viseme feature flow data according to the viseme feature data respectively corresponding to the sets of phoneme data.

17. A computer device comprising:
a memory; and
one or more processors,
wherein the memory stores computer-readable instructions, and the processor, when executing the computer-readable instructions, causes the computer device to perform:
feature analysis based on a target audio, to generate viseme feature flow data, the viseme feature flow data comprising a plurality of sets of ordered viseme feature data, each set of viseme feature data corresponding to one audio frame in the target audio, respectively;
separate parsing of each set of viseme feature data, to obtain viseme information and intensity information corresponding to the respective set of viseme feature data, the intensity characterizing a change intensity of a viseme corresponding to the viseme information; and
controlling, according to the viseme information and the intensity information corresponding to the sets of viseme feature data, a virtual face to change, so as to generate a mouth shape animation corresponding to the target audio.

18. The computer device according to claim 17, wherein the feature analysis based on a target audio, to generate viseme feature flow data, comprises:
performing the feature analysis based on the target audio, to obtain phoneme flow data, the phoneme flow data comprising a plurality of sets of ordered phoneme data, each set of phoneme data corresponding to one audio frame in the target audio respectively;
for each set of phoneme data, performing analysis processing on the respective set of phoneme data according to a preset mapping relationship between a phoneme and a viseme, to obtain the viseme feature data corresponding to the phoneme data; and
generating the viseme feature flow data according to the viseme feature data respectively corresponding to the sets of phoneme data.

19. One or more computer-readable storage media, storing computer-readable instructions, the computer-readable instructions, when executed by one or more processors, causes a computing apparatus to:
perform feature analysis based on a target audio, to generate viseme feature flow data, the viseme feature flow data comprising a plurality of sets of ordered viseme feature data, each set of viseme feature data corresponding to one audio frame in the target audio, respectively;
separately parse each set of viseme feature data, to obtain viseme information and intensity information corresponding to the respective set of viseme feature data, the intensity characterizing a change intensity of a viseme corresponding to the viseme information; and
control, according to the viseme information and the intensity information corresponding to the sets of viseme feature data, a virtual face to change, so as to generate a mouth shape animation corresponding to the target audio.

20. The one or more computer-readable storage media of claim 19, wherein the computing apparatus is further caused to:
perform the feature analysis based on the target audio, to obtain phoneme flow data, the phoneme flow data comprising a plurality of sets of ordered phoneme data, each set of phoneme data corresponding to one audio frame in the target audio respectively;
for each set of phoneme data, perform analysis processing on the respective set of phoneme data according to a preset mapping relationship between a phoneme and a viseme, to obtain the viseme feature data corresponding to the phoneme data; and
generate the viseme feature flow data according to the viseme feature data respectively corresponding to the sets of phoneme data.
